(19) United States
(12) Patent Application Publication
(10) Pub. No.: US 2025/0383249 A1
(43) Pub. Date: Dec. 18, 2025

(54) SYSTEMS, APPARATUS AND METHODS FOR SENSING FORCE AND TORQUE

(71) Applicant: The Trustees of Columbia University in the City of New York, New York, NY (US)

(72) Inventors: Matei CIOCARLIE, New York, NY (US); Ioannis KYMISSIS, New York, NY (US)

(21) Appl. No.: 19/237,856

(22) Filed: Jun. 13, 2025

Related U.S. Application Data
(60) Provisional application No. 63/659,685, filed on Jun. 13, 2024.

(51) Int. Cl. G01L 1/24

(52) U.S. Cl. CPC G01L 1/241

(57) ABSTRACT

Systems, apparatus and methods are disclosed for force and torque sensing techniques including a first structure having a first surface, a second structure having a second surface, and an elastic material connecting the first surface and the second surface. The elastic material is configured to displace in response to an external force. A light source attached to the first surface emits a light beam and a light receiver attached to the second surface receives the light beam. The change of the light beam is based on displacement of the elastic material in response to the external force. The light source can be a light-emitting diode (LED) or laser. The light receiver can be a photodiode or LED. A data converter translates the change of the light beam to a digital signal, which can control an actuator. The digital signal can be further processed.

This application claims the benefit of priority to U.S. Provisional Application No. 63/659,685, entitled “Systems, Apparatus and Methods for Sensing Force and Torque,” filed on Jun. 13, 2024, the disclosure of which is incorporated by reference herein in its entirety.

This invention was made with government support under 2037101 awarded by the National Science Foundation. The government has certain rights in the invention.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### TECHNICAL FIELD

Embodiments of the disclosure relate generally to sensing technology. In some non-limiting implementations, the disclosure relates to sensing force and torque in robotic manipulation.

### BACKGROUND

Force and torque sensing technology is applied in a wide range of industries and applications, such as robotics. For example, a robotic force and torque sensor can measure force and torque when they are applied and generate a signal for measuring and recording in robotic systems. With force and torque sensing technology, various physical parameters can be artificially captured and processed by systems employing robotics and/or other automated devices.

A method for sensing such forces and torques is to incorporate an off-the-shelf six-axis force and torque (F/T) sensor into a base of a finger. However, such F/T sensors are primarily developed with industrial applications in mind, leading to limitations when being used for dexterous manipulation. Manipulation often benefits from compliance, whereas most F/T sensors are optimized to be as stiff as possible, thus requiring precision engineering and leading to a high cost. Industrial applications also tend to favor a higher resolution than is needed for manipulation but compromise by limiting the overload protection. This leads to sensors that are easily damaged in the uncertain environments that robotics need to interact with. Finally, some F/T sensors can be difficult to package and integrate into the hand. There are also limits with respect to the geometry of the finger and the inclusion of other modalities within the finger.

### SUMMARY

Systems, apparatus and methods are disclosed for force and torque sensing technology. In one embodiment, a sensing apparatus is provided that comprises a first structure having a first surface; a second structure having a second surface; an elastic material connecting the first surface of the first structure and the second surface of the second structure, the elastic material configured to displace in response to an external force; a light source attached to the first surface of the first structure, the light source configured to emit a light beam; and a light receiver attached to the second surface of the second structure, the light receiver configured to receive the light beam, wherein an amount of the received light beam in relation to the emitted light beam is based on displacement of the elastic material in response to the external force. In another embodiment, the first structure is configured to move with at least one degree of freedom. In another embodiment, the second structure is configured to move with at least one degree of freedom. In another embodiment, the elastic material is a flexible structure configured to support an air gap.

In another embodiment, the light source is a light-emitting diode (LED). In another embodiment, the light source is a laser device.

In a further embodiment, the light receiver is a photodiode. In another embodiment, the light receiver is a light-emitting diode (LED).

In another embodiment, the sensing apparatus further comprises a data converter configured to translate the amount of the received light beam to a digital signal. In another embodiment, the sensing apparatus further comprises an actuator device, wherein the digital signal is configured to control a torque of the actuator device.

In a further embodiment, a sensing method is provided that comprises connecting, by an elastic material, a first structure having a first surface and a second structure having a second surface; emitting, by a light source attached to the first surface of the first structure, a light beam; receiving, by a light receiver attached to the second surface of the second structure, the light beam; and measuring an amount of the received light beam in relation to the emitted light beam, wherein the measured amount of the received light beam is based on displacement of the elastic material in response to the external force. In another embodiment, the sensing method further comprises translating, by a data converter, the amount of the received light beam to a digital signal. In another embodiment, the sensing method further comprises controlling, by the digital signal, a torque of an actuator device.

In yet another embodiment, a sensing system is provided that comprises a first structure having a first surface; a second structure having a second surface; an elastic material connecting the first surface of the first structure and the second surface of the second structure, the elastic material configured to displace in response to an external force; a light source attached to the first surface of the first structure, the light source configured to emit a light beam; a light receiver attached to the second surface of the second structure, the light receiver configured to receive the light beam, wherein an amount of the received light beam in relation to the emitted light beam is based on displacement of the elastic material in response to the external force. A data converter is configured to translate the amount of the received light beam to a digital signal; and one or more processors are configured to process the digital signal. In another embodiment, the one or more processors of the sensing system are configured to process the digital signal using a machine learning model.

### BRIEF DESCRIPTION OF THE DRAWINGS

Various objectives and features of the disclosed subject matter can be more fully appreciated with reference to the following detailed description of the enclosed subject matter when considered in connection with the following drawings. The following drawings should not be construed as limiting the present disclosure and are intended to be illustrative only.

FIG. 1 illustrates a finger link integrated with a 6-axis force/torque sensor, according to an embodiment.

FIG. 2 illustrates a force torque sensor, according to an embodiment.

FIG. 3 illustrates another force torque sensor, according to an embodiment.

FIG. 4 illustrates a test rig for a force torque sensor, according to an embodiment.

FIGS. 5A-5D show readings of Position Sensitive Devices (PSD) and a Photodiode, according to an embodiment.

FIGS. 6A-6B show performance of an LED used as a diode, in accordance with an embodiment.

FIG. 7 is a simplified block diagram illustrating communication protocol between a microcontroller and sensors, according to an embodiment.

FIGS. 8A-8B illustrate a CAD rendering of a sensor design, according to an embodiment.

FIGS. 9A-9D illustrates a printed circuit board (PCB) design for sensors, according to an embodiment.

FIG. 10 illustrates a force torque sensor, according to an embodiment.

FIG. 11 illustrates a sensor with a PCB design, according to an embodiment.

FIG. 12 illustrates a sensor with a PCB design, according to an embodiment.

FIGS. 13A-13B illustrate sensor results for an applied force, in accordance with an embodiment.

FIGS. 14A-14E illustrate performance differences between photodiode, PSD, and LED implementations, according to an embodiment.

FIGS. 15A-15D illustrate performance differences between photodiode and LED implementations, according to an embodiment.

FIGS. 16A-16B show performance of an LED implementation, according to an embodiment.

FIGS. 17A-17G illustrate footprints of photodiode and LED implementations, according to an embodiment.

FIG. 18 illustrates a sensing apparatus mounted with force and torque sensors, according to an embodiment.

### DETAILED DESCRIPTION

Embodiments disclosed herein are related to sensing force and torque. In an embodiment, a key focus in robotic manipulation is the ability to sense both an internal and external state, including position and force, of an entire manipulator. Proprioception describes the ability to sense internal position and torques, while haptic control encompasses interactions between a robot and external forces. In aiming to build a general dexterous robot manipulator, a robot hand can be designed to achieve both proprioceptive and haptic control, by 1) sensing external forces and 2) sensing both joint torque and position. Designing a robot hand to accomplish both of these goals is difficult, as manipulators are designed to be compact and lightweight. With such a confined design space, mechanisms designed to achieve these goals may have some form of limitation or set-back. In the current disclosure, various techniques are utilized to achieve design criteria and initial development of a 6-axis force/torque sensor to sense external forces in robot manipulators.

A sensor for integration in robot fingers is disclosed in accordance with an embodiment, where it can provide information on displacements induced by external contact. The sensor can use LEDs to sense displacement between two plates connected by a transparent elastomer. When a force is applied to the finger, the elastomer displaces and the LED signals change. Using LEDs as both light emitters and receivers provides high sensitivity, allowing such an emitter and receiver pairs to detect very small displacements. The standalone performance of the sensor by testing the ability of a supervised learning model to predict complete force and torque data from its raw signals, in an example, achieves a mean error between 0.05 and 0.07 N across the three directions of force applied to the finger. In an embodiment, the sensor allows for finger-size packaging with no amplification electronics, low cost manufacturing, easy integration into a complete hand, and high overload shear forces and bending torques, suggesting future applicability to complete manipulation tasks. As motor learning for dexterous manipulation makes continuous advances, sensing techniques are key for future performance of robot hands. Having a multitude of sensors increases the ability of combining a right sensor with a right motor learning method to achieve novel capabilities.

Detecting net forces or torques acting on a robotic finger is useful for dexterous manipulation, with the potential to replace or complement tactile sensors. Tactile sensors convey significantly more information, such as an exact or precise location of contact or a pressure map, from which net finger forces can also be extracted. However, tactile sensors offering full fingertip coverage are still not ubiquitous technology. In their absence, information on net forces and torques can still be useful in robot fingers engaged in manipulation tasks.

A displacement sensor is disclosed in accordance with an embodiment, which provides information about the net forces acting on a robot finger in a manner that addresses the needs of robotic manipulation. An exemplary embodiment has the following characteristics. First, such a sensor is easy to manufacture using low-cost components and processes, so that it is affordable and practical to include multiple in a multi-fingered hand. Second, it has the size and profile suited for the base of a fingertip, which will increase case of integration into a hand. This also frees up the finger design for alternate sensors and allows more flexibility in design of a finger. Third, some amount of compliance can be beneficial to manipulation, and thus there is no need to avoid compliance at all cost. Finally, its Signal to Noise Ratio (SNR) allows it to be useful for manipulation without sacrificing overload protection.

In an embodiment, a sensor is based on light transport. It consists of two plates, connected by an elastomer layer that allows for 6 Degrees of Freedom (DOF) between them. When mounted at the base of a robot finger, any contact force applied to the finger will cause a displacement between these plates. To measure this displacement, a network of LEDs on each plate are implemented as both light emitters and light receivers. As the plates shift relative to each other due to externally applied forces, the signal measured by the receiver LEDs changes due to the relative movement and positioning of the emitter LEDs. These signals are recorded and used to extract information about the forces acting on the finger.

By using LEDs as both emitters and receivers, the sensor confers very high signal-to-noise ratio, significantly higher than using photodiodes. Combined with the small LED form factor, this allows sensing very small displacements in a compact package, for instance, with a resolution of 0.06 N and 2.6 N-mm in a compact, low-cost package that is compliant and easy to integrate in robot fingers as it requires no external amplification. In an embodiment, LEDs have been integrated into a 6-DOF flexure, allowing for full contact information in a compact, complaint robot fingers. The sensor is designed to be integrated at the base of a finger, which allows for sensing coverage of the entire finger and the ability to integrate other sensors in the finger. The sensor can facilitate truly ubiquitous sensing integrated in robot fingers, with future applications in manipulation. The flexure can support multiple types of flexible layers between the two plates, such as an air gap, a polydimethylsiloxane (PDMS) layer, etc. The flexure can be made by ways including 3-D printing, laser cut, metal, wave springs, etc. The characteristics of the flexure and the flexible layer can affect the stiffness and robustness of the overall sensor.

Displacement transduction via light measurements offers, for example, three advantages. First, it provides a fast response time, as diode readings are gated by the ADC rather than the diodes. Second, its components require minimal space, which aids with reducing the footprint. Third, LEDs can be selected in an IR spectrum, making the sensor resistant to the majority of external environment light. Adding an opaque wrapping to the outside of our sensor can further help prevent interference from external infrared light.

Using LEDs as both a receiver and emitter provides further advantages over other modalities. For instance, light can be sensed at very high frequencies with minimal electrical noise. LEDs have a smaller form factor than most photodiodes that are comparable in costs. LEDs are optimized for operation in their wavelength range, making it easier to design features to minimize external interference. LEDs have a smaller viewing angle, which is useful for increasing sensitivity given size constraints. LED receivers exhibit much higher sensitivity compared to its photodiode counterpart. For example, an LED receiver can identify displacements as small as 0.01 mm, whereas the corresponding signal changes for a photodiode receiver are comfortably inside the noise level.

In an embodiment, for collecting sensing data, multiple contact locations are distributed evenly around the circumference of a finger structure on top of a sensor. Contacts may be applied by pressing against the printed finger with a fingertip. These contacts may be grouped into several sets, each recorded at different heights-top, middle, and bottom of the finger. Each set can focus on a specific force range to ensure comprehensive coverage. A test set may be randomly split across height groupings to be representative of different torque-force pairings.

In an embodiment, a 6-axis force/torque sensor is provided that can be affordably and practically integrated in series with a rigid form of actuation. There are multiple exemplary objectives, including building a sensor that is affordable, as compact as possible e.g., <25 mm in diameter, and able to withstand forces beyond a sensing threshold, e.g., roughly >10N.

For designing miniature force/torque sensors for robot manipulators, relevant 6-axis sensor designs are compared in Table 1 below, with their relevant performance characteristics.

TABLE 1
Comparison of Existing Novel 6-axis F/T Sensors

| | | | Minimum Forces | Maximum Forces and | | |
|---|---|---|---|---|---|---|
| Modality | Cost | Size | and Torques | Torques | Accuracy (R²) | Bandwidth |
| Barometer | $20 | L: 75 mm | Fx - <0.1N | Fx - 30N | Fx - 0.937 | 50 Hz |
| | | W: 75 mm | Fy - <0.1N | Fy - 40N | Fy - 0.909 | |
| | | H: 5 mm | Fz - <0.1N | Fz - 10N (tension) | Fz - 0.998 | |
| | | | Mx - <0.1N*mm | Fz - 10N (compression) | Mx - 0.984 | |
| | | | My - <0.1N*mm | Mx - 40N*mm | My - 0.984 | |
| | | | Mz - <0.1N*mm | My - 40N*mm | Mz - 0.991 | |
| | | | | Mz - 30N*mm | | |
| Camera | $40 | L: 35.7 mm | Fx - 0.1N | Fx - 65N | Fx - 0.991 | 25 Hz |
| | | W: 22.5 mm | Fy - 0.1N | Fy - 18N | Fy - 0.996 | |
| | | H: 51 mm | Fz - 0.1N | Fz - 0.1N (tension) | Fz - 0.875 | |
| | | | Mx - 0.5N*mm | Fz - 80N (compression) | Mx - 0.997 | |
| | | | My - 0.5N*mm | Mx - 80N*mm | My - 0.997 | |
| | | | Mz - 0.5N*mm | My - 40N*mm | Mz - 0.902 | |
| | | | | Mz - 4N*mm | | |
| Camera | $400 | L: 35 mm | Not reported | Fx - 10N | Fx - 0.993 | 40 Hz |
| (Visiflex) | | W: 35 mm | | Fy - 10N | Fy - 0.980 | |
| | | H: 35 mm | | Fz - 0.1N (tension) | Fz - 0.988 | |
| | | | | Fz - 10N (compression) | Mx - 0.986 | |
| | | | | Mx - Not reported | My - 0.980 | |
| | | | | My - Not reported | Mz - 0.985 | |
| | | | | Mz - Not reported | | |
| Capacitance | ~$100 | Rad: 14 | Fx - 8.1 mN | Fx - 30N | Errors: | 200 Hz |
| | | mm | Fy - 10.2 mN | Fy - 30N | Fx - 0.276N | |
| | | H: 6.5 mm | Fz - 5.4 mN | Fz - 30N (tension) | Fy - 0.249N | |
| | | | Mx - 0.25N*mm | Fz - 30N (compression) | Fz - 0.471N | |
| | | | My - 0.23N*mm | Mx - 0.30N*m | Mx - 4.86N*mm | |
| | | | Mz - 0.1N*mm | My - 0.30N*m | My - 5.13N*mm | |
| | | | | Mz - 0.30N*m | Mz - 1.71N*mm | |

In an embodiment, a sensor with capacitance modality fits many of the design criteria to be achieved. However, capacitance as a sensing element is prone to external interference. Additionally, error can be high, especially considering that for in-hand manipulation an approximate contact force is ˜1N. This error can be mitigated by choosing an appropriate sensing modality and designing a robust flexure that can withstand high forces, but also one that yields low errors and can be sampled quickly.

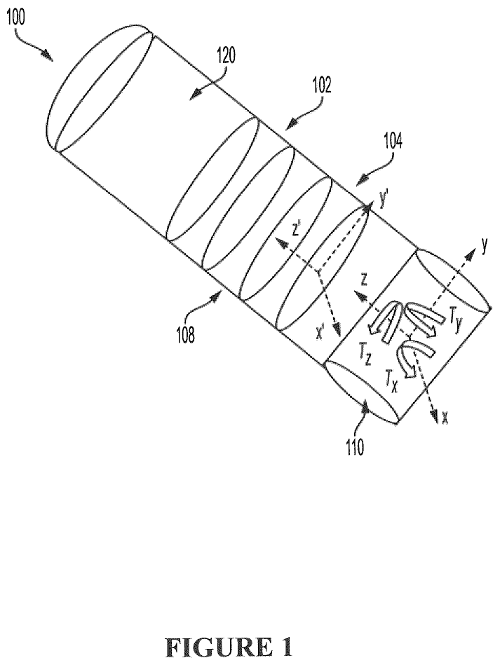

FIG. 1 illustrates a finger link integrated with a sensor 100, according to an embodiment. In the illustrated example, the sensor is a 6-axis force/torque sensor composed of two rigid plates 102 and 104, housing electronic devices for sensing. Between the two plates 102 and 104 is a flexible layer 108 comprising an elastic material. Other solid structures can also be used on both ends of the flexible layer 108 for housing the devices for sensing. In some embodiments, the two plates 102 and 104 are connected by a soft elastomer, for instance, polydimethylsiloxane (PDMS), in the middle as the flexible layer 108. A motor 110 is shown at the bottom and generates internal torque. There is also an external contact 120 configured to apply an exerted force. The 6-axis sensor allows sensing of such externally exerted forces and torques, that can be used, for example, as low-level controllers to control actuator torque. In some embodiments, the two plates 102 and 104 are connected by flexures supporting an air gap as the flexible layer 108.

An affordable, compact, and robust 6-axis force-torque sensor is disclosed along with aspects regarding selecting the appropriate electronic sensing modality.

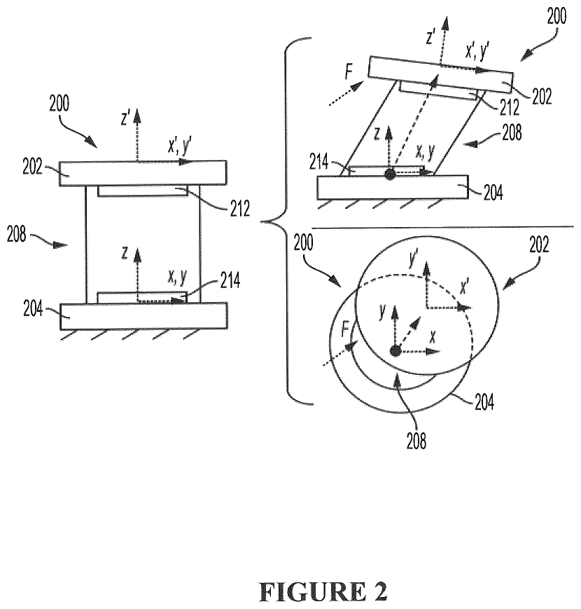

FIG. 2 illustrates a force torque sensor 200, according to an embodiment. In the illustrated example, the sensor 200 includes two rigid elements 202 and 204 connected in series by some flexure 208 that allows for 6-degrees of freedom (6-DOF) movement of the rigid elements 202 and 204, such as rigid plates. Devices 212 attached to the rigid element 202 and devices 214 attached to the rigid element 204 are for transmitting and receiving signals for sensing. The flexure 208 is an elastic material that has a particular stiffness (K). With an applied force (F), the rigid elements 202 and 204 will displace according to Hooke's Law. By tracking the displacement with signals using devices 212 and 214, the applied force/torque can be calculated with the material properties. In some embodiments, the two rigid elements 202 and 204 are connected by the flexure 208 supporting an air gap.

Aspects of hardware and software design are disclosed. At a high level, a force-torque sensor exploits Hooke's Law governing linearly elastic materials, in which an external force applied on an object will cause a particular deformation. This concept is visualized in FIG. 2 as described above, where there are two rigid plates connected by an elastic flexure and an applied force causes deformation in the 6-axis (3 linear forces and 3 torques). With the material properties of the elastic flexure, the deformation of the flexure through mounting electronics on the plates can be tracked, then the applied force on the sensor can be determined. The deformation can be tracked by sensing the displacement of the plates in six-axis.

In an embodiment, sensor techniques include measuring this displacement by placing light emitters on one plate (e.g. the top plate in FIG. 2), and light receivers on the other plate (e.g. the bottom plate in FIG. 2). The amount of light going from the emitters to the receivers provides a measurement of the displacement between the plates. In various examples, there are multiple options for what the light emitters can be. These include but not limited to LEDs, lasers, and other light sources. Similarly, there are multiple options for what the light receivers can be. These include but not limited to photodiodes, LEDs used as photodiodes, etc.

The signal from the light receivers can be read, which provides a measurement of how the light emitters have shifted with respect to the receivers. The measurement in turn provides a measurement of the displacement between the plates. Then, the measurement of the displacement can be translated into a measurement of the force and torque applied between the plates. This translation can be carried out via a data-driven, machine learning method, without needing to determine an analytical model for it.

In embodiments, sensor techniques include measuring displacement between the top and bottom plate using light transmission through a transparent elastomeric medium between the plates; using LEDs as both the light source and the light receiving method, therefore providing extremely high sensitivity and very low signal-to-noise, while still using low cost components and manufacturing methods; using multiple light emitter-receiver pairs embedded in the sensor in order to obtain numerous measurements pertaining to the displacement; and using data-driven, machine learning algorithms to map from raw light receiver signals to the net force/torque being applied between the plates.

In an embodiment, prior to training with collected sensor data, a series of pre-processing techniques can improve data quality and model performance. To reduce high-frequency noise, median filters on the raw sensor readings and on the ground raw data are used. Based on data collection rate, for instance, 250 Hz, this filtering process introduces a delay, which is negligible for application. To distinguish between contact and non-contact states, all data points are thresholded with a total force magnitude. Additionally, instead of training directly on raw signals, extracted features based on their relative changes from a no-contact baseline may be used. For example, this baseline can be defined as the mean of a first range of data points in each recorded dataset. To further stabilize training and maintain numerical consistency, all features and labels may be normalized prior to training. These pre-processing steps can help the model focus on signal variations rather than absolute values, enhancing generalization.

In an embodiment, learning algorithms are implemented on collected sensor data. For example, an updated Residual Network (“ResNet”) based architecture includes a shared feature extraction backbone followed by six independent task-specific heads, one for each of the six DOFs in force and torque prediction. The model has a residual block with 1D convolutional layers. Each residual block integrates 1D convolutional layers, skip connections and ReLU activation functions to enhance feature extraction while mitigating vanishing gradients. The input to the model is a multi-channel time-series sequence, corresponding to the preprocessed sensor signals. A 1D convolutional layer with an enlarged kernel is applied before the residual blocks to capture global patterns in the sensor signals. This is followed by a shared backbone, which is a 1D ResNet specifically designed for sequential sensor data. The backbone includes multiple residual blocks that efficiently capture spatial and temporal dependencies.

After the shared backbone, the model branches into multiple independent prediction heads, each dedicated to estimating a specific force or torque component. Each head includes additional residual layers, a global average pooling layer, and a fully connected output layer that generates a single scalar value. This multi-task learning framework enables specialized feature extraction while leveraging shared representations, thereby enhancing generalization across different force and torque components. The model is trained using a mean squared error (MSE) loss function, applied separately to each output head. Training is conducted for multiple epochs using the Adam optimizer with a predetermined batch size, and an initial learning rate, which is adjusted dynamically using a LambdaLR scheduler.

In other embodiments, displacement can be directly measured through vision, where the position of fiducial markers is tracked. One can also indirectly measure the displacement through some other sensing modality, such as pressure or capacitance.

Electronics component selection and design approaches are disclosed. For verifying that diodes have a required sensitivity, a test rig is used to measure the response, signal, and noise. The setup is able to read at least. 1 mm of deflection, and the smaller that can be read the more rigid the design can be. The test rig allows moving two protoboards with sample electronics across 1-axis at a time, either horizontally or vertically, using a servo motor controlled by a microcontroller development board (e.g., Teensyduino.) This allows measuring the signal change over set displacements. In one example, the range of the test rig is about 30 mm horizontally, and about 10 mm vertically, ranging from about 8.8 mm to about 18.8 mm vertical distance between the two protoboards.

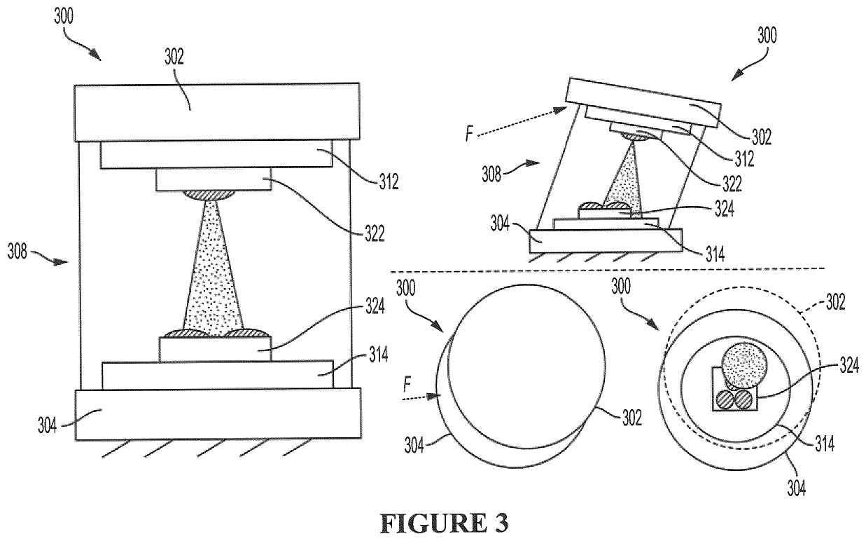

FIG. 3 illustrates another force torque sensor 300, according to an embodiment. In the illustrated example, the sensor 300 includes two rigid elements 302 and 304 connected in series by a flexure 308 that allows for 6-degrees of freedom (6-DOF) movement of the rigid elements 302 and 304, such as rigid plates. Devices 312 attached to the rigid element 302 and devices 314 attached to the rigid element 304 are for transmitting and receiving signals for sensing. In an example, devices 312 and 314 are LED circuit boards including LEDs. Devices 312 include an emitter 322 and devices 314 include a receiver 324. The emitter 322 and the receiver 324 can also be a cluster of emitting and receiving units, respectively. The flexure 308 is an elastic material that has a particular stiffness (K). With an applied force (F), the rigid elements 302 and 304 will displace according to Hooke's Law. By tracking the displacement with signals using devices 312 and 314, the applied force/torque can be calculated with the material properties. In some embodiments, the two rigid elements 302 and 304 are connected by the flexure 308 supporting an air gap.

At a neutral position, the emitter 322 is above, and may be directly above, the center of the receiver 324. When an external force is applied, the rigid elements 302 and 304 will displace relative to each other. This displacement will result in a change in signal for the receiver 324 due to the relative motion of the corresponding emitter 322. A data processor can then map this change in signal back to determine the contact force and torque applied.

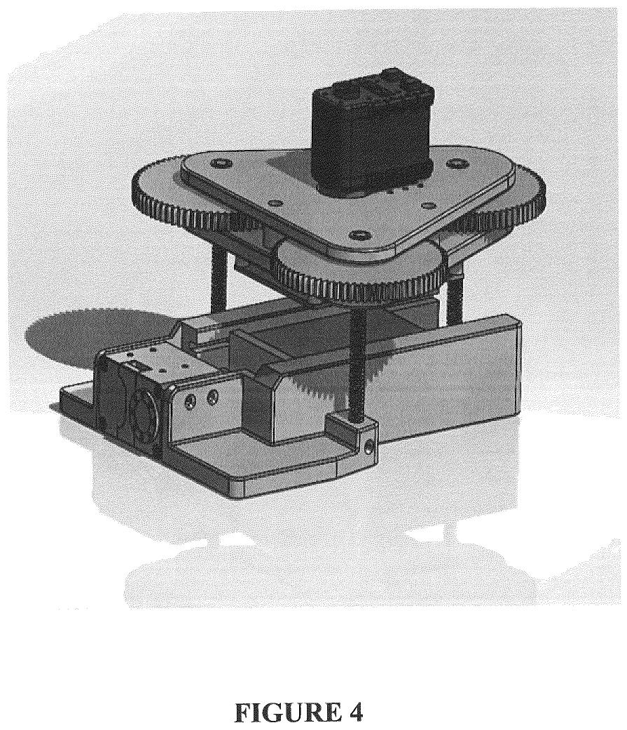

FIG. 4 illustrates a test rig, according to an embodiment. The servo on top controls three gears to provide vertical motion. The servo at the base provides horizontal motion. In some examples, the test rig can do simultaneous two axis motion. In other examples with different types of servos, they cannot be daisy chained.

In another embodiment, a test rig only has horizontal motion.

In another embodiment, IR LEDs and photodiodes are used to minimize noise from outside light. For example, SFH 4045N from Osram can be used as an LED, as it has a narrow view cone (a half angle of about) 9°. Another example is the BPW 34 S E9601 also from Osram. Position Sensitive Devices (PSDs), which are 4 quadrant photodiodes designed to calculate the center of a mass of a beam of light, can be used, too. This allows tracking of displacement of the light beam relative to a central resting position, and serves as a higher response time version of cameras are used for. A Teensyduino 3.6 can also used with its built-in Analog to Digital Converter (ADC—a device that transforms the analog signals from the diodes to a digital reading that we can use in software) to take these measurements at around 10 KHz.

In another embodiment, four photodiodes are arranged in a grid. One advantage of this is that it has a tighter packaging than four separate photodiodes, but in an embodiment, the lead design may require keeping it in reverse-biased mode rather than zero-biased. Reverse bias-mode increases response time at the cost of increased noise and decreased range of signal, which decreases the sensitivity of readings. As a result, readings from the single photodiode outclass that of the PSD. Primarily, the signal-noise on 0.1 mm displacement, the smallest to be confidently read, may be unusable on the PSD. While the Photodiode may be noisy, there is clear signal that can be interpreted over the noise. This is evidenced in the graphs in FIG. 4 as described below.

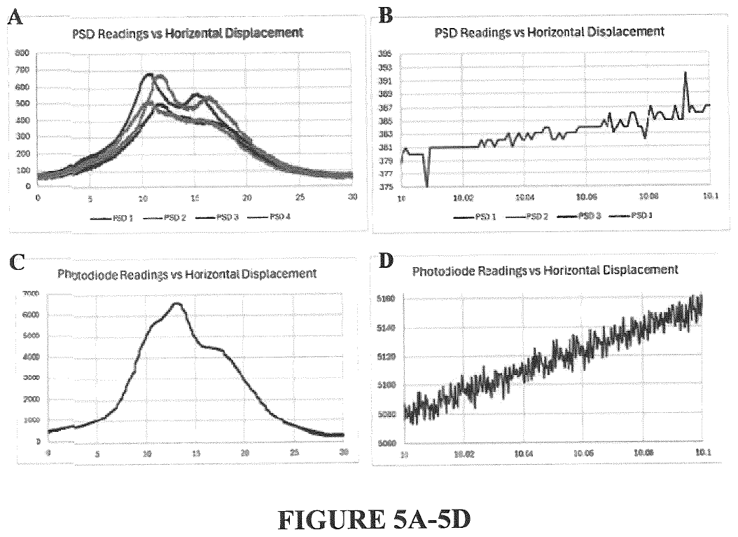

FIGS. 5A-5D show the PSD and Photodiode in a full 30 mm sweep, according to an embodiment. Notably, the PSD has a specific pattern as the light sweeps across it, and nearly undecipherable noise when zoomed in. The hills in the photodiode readings are possibly artefacts of the physical design of the test rig.

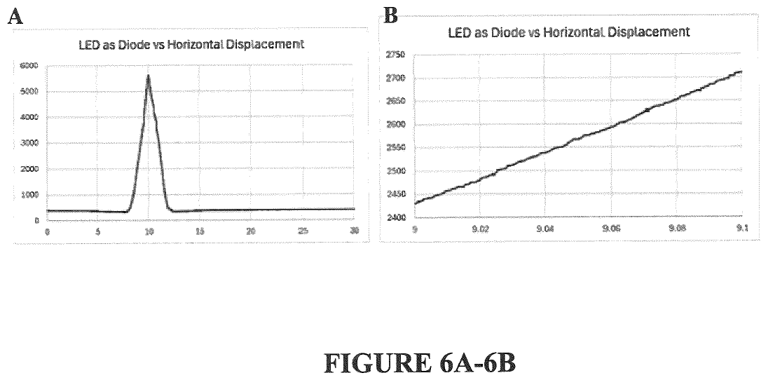

Using LEDs as light receivers, in accordance with an embodiment, can function as photodiodes, rather than using dedicated photodiodes. For example, when using an identical SFH 4045N LED to read the intensity, the signal is less noisy, and has a smaller but sharper region of sensitivity. On top of that, the LED has a smaller footprint than the photodiode. This is shown in FIG. 6 as described below. As a result, using LEDs as both light emitters and receivers, for a sensor as disclosed in the current application, has improved performance.

FIGS. 6A-6B show the horizontal sweep of an LED as diode, in accordance with an embodiment. Notably the LED has less noise relative to the signal, and a much sharper response window (about 5 mm in width). Peak signal is slightly less but it does not saturate.

In an embodiment, printed circuit board (PCB) design is for transferring data from the sensors to a microcontroller and eventually a computer for processing by Multilayer Perceptrons (MLP). To limit the number of cables, routing can be between the sensor and the control, while using a chip on board to limit the amount of signals ranging from 1 per LED to as few as possible. The following examples are disclosed and compared.
Design A: Using a microcontroller on the board directly, handling the readings with its built-in ADC, and avoiding having to place a microcontroller somewhere in the wrist.
Design B: Having both an on board microcontroller and an external ADC, which would allow for higher quality readings and still keep the microcontroller on board.
Design C: Moving the microcontroller off board but keeping the ADC on board, allowing the benefit of the better readings from an ADC and the use of its built in Multiplexer (MUX—a device for selecting one signal from many).
Design D: Simply using a MUX on board and using the off-sensor microcontroller as an ADC.

TABLE 2
A summary of the four designs discussed above.

| | uC on | Standalone | MUX on | Offboard |
|---|---|---|---|---|
| | plate | ADC | plate | Communication |
| Design A | Yes | No | No | Serial |
| Design B | Yes | Yes | No | Serial |
| Design C | No | Yes | No | SPI |
| Design D | No | No | Yes | Digital & Analog lines |
| | | | | DISCO style |

In some examples, the footprint with an onboard microcontroller may be too much for size restrictions, whereas the difference between an ADC and MUX was negligible, while giving higher quality readings, and allowing communication with multiple devices across a Serial Peripheral Interface (SPI) bus. Furthermore, the MUXs in the ADC are designed for rapid signal processing, avoiding issues with MUXs.

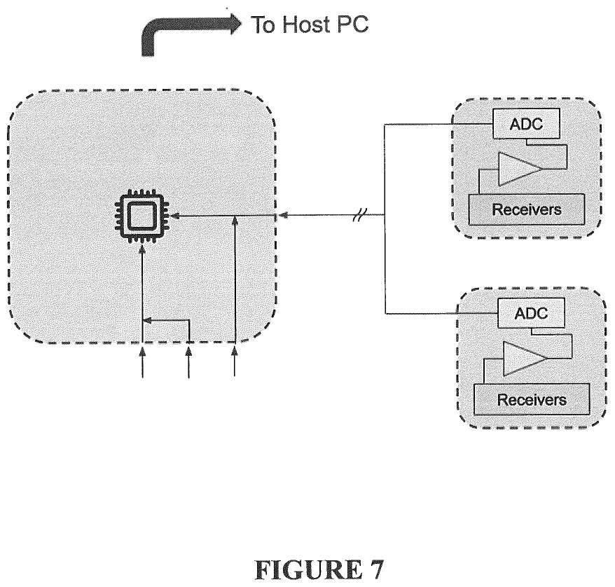

FIG. 7 illustrates a block diagram showing a communication protocol between a wrist mounted microcontroller (e.g., Teensy) and the sensors, according to an embodiment. The microcontroller communicates using the SPI to the plates, which allows it to select which plate it is talking to and receive inputs from the ADC sequentially. SPI also carries power to the sensor.

An initial routing is done with an on board ADC. In an example design, there is a grid of 5 receivers per emitter, a board used on the bottom plate which receives signals, and a board on the top plate which emits the signals. This presented two considerations: First, there is unused space on the top plate, as it just required some LEDs, resistors, and power. Second, there is a lack of space on the bottom plate, as an op-amp is needed for every four LEDs, and a total of six receiver-emitter pairs (and thus 30 receiver LEDs, and eight op-amps) are needed. As an alternative, the difference can be split by setting up three receivers and three emitters per board, and designing the boards such that they are identical at around 60° offset. This means that each board only has 15 Diodes and needs only four Op-Amps, and would each have their own ADC. It also allows designing and printing a single board which will reduce PCB manufacturing cost.

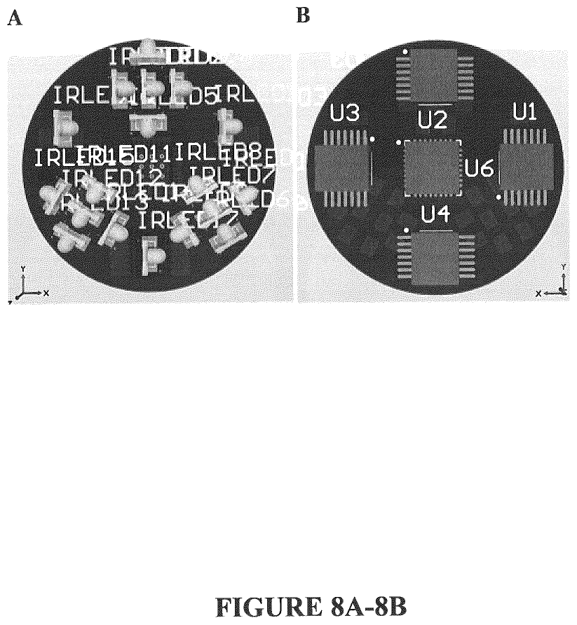

FIGS. 8A-8B illustrate a CAD rendering of the modified original design, according to an embodiment. In the illustrated example, it has 5 receivers per emitters, an ADC chip and 4 op-amps. Not shown are any of the resistors or capacitors needed, nor the FFC connection port.

The process of the routing, fitting 4 op-amps with all the required resistors, capacitors, Flat-Flexible Cable (FFC) connectors, and mounting, can be challenging within the around 1-inch circle. With 4 receivers per emitter, the footprint can be reduced to 3 op-amps per board. The footprint can also be changed from a, e.g., 1-inch circle to a hexagon inscribed within that circle, which allows expanding mechanical design options.

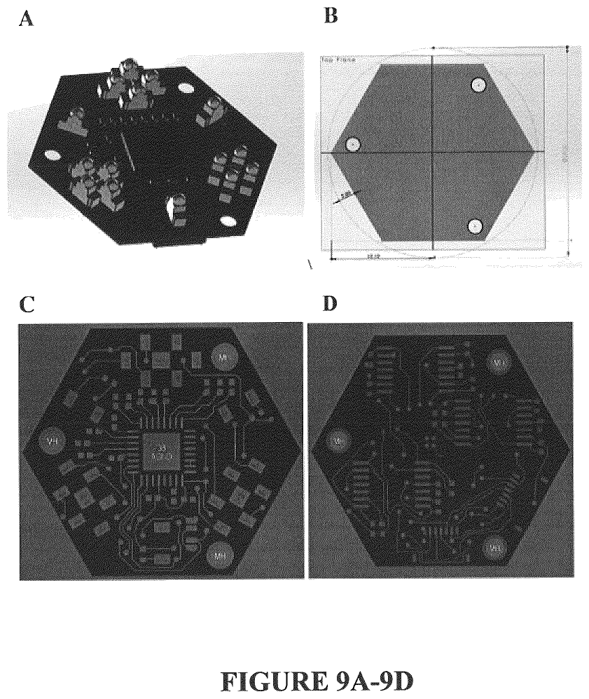

FIGS. 9A-9D illustrate a PCB draft in CAD and PCB routing, according to an embodiment. The CAD shows the updated four receiver design along with a depiction of the inscribed hexagon, and 3 holes left for mounting. The left image shows the top layer with the ADC and all the LEDs, and the right image shows the bottom layer with various routings and electronics.

In an embodiment, evaluating our schematic shows problems tied to mechanical constraints. First, LEDs are around 3 mm tall, eating up a lot of vertical height to give them appropriate spacing, especially with the narrow cone. Secondly, even with the 3 op-amps, the full 25 mm is needed as the size of our PCB plate, which limits how small the sensor can be. Third, the FFC cables used for SPI have a current restriction that needs another power line in order to effectively power all the emitters. As a result, improvements can be made of a PCB schematic, like using a flatter LED (approximately 1 mm tall) with a wider view cone. This allows the plates to be closer together while getting a more diverse signal.

TABLE 3
Comparison between average max range and
experimentally derived properties.

| | average | | |
|---|---|---|---|
| | max | Derived | |
| | range | Properties | Ratio |
| Elastic Modulus [Pa] | 330000 | 187000 | 1.764705882 |
| Shear Modulus [Pa] | 250000 | 872000 | 0.2866972477 |
| Tensile Strength [Pa] | 900000 | 935000 | 0.9625668449 |
| Compressive Strength [Pa] | 1010000 | 4930000 | 0.2048681542 |
| Yield Strength [Pa] | 700000 | 728270 | 0.9611819792 |

For mechanical analysis and design, as described above in FIG. 2, the actual sensor is composed of two rigid plates that house the PCBs and a flexure to connect them. The mechanical design philosophy is that less is more. Minimal features are designed on the plates such that they are simple and easy to fabricate. There are three main criteria for the mechanical design: 1) the plates are sensitive to at least 0.1 N of force; 2) the flexure should allow the sensor to detect displacements caused by at most 10 N; 3) the plates are able to withstand forces well-beyond desired maximum force without breaking. When applying a force to the sensor, the plates will displace. For the minimum force, the sensor will need to deform so that the electronics can see a change in signal related to the force. For the maximum force, the displacement caused by the force does not move the electronics out of their sensing range in which the design is either saturated or does not pick up a signal at all. Finite element analysis (FEA) allows design of the geometry of the plates and the flexure meeting all the criteria above.

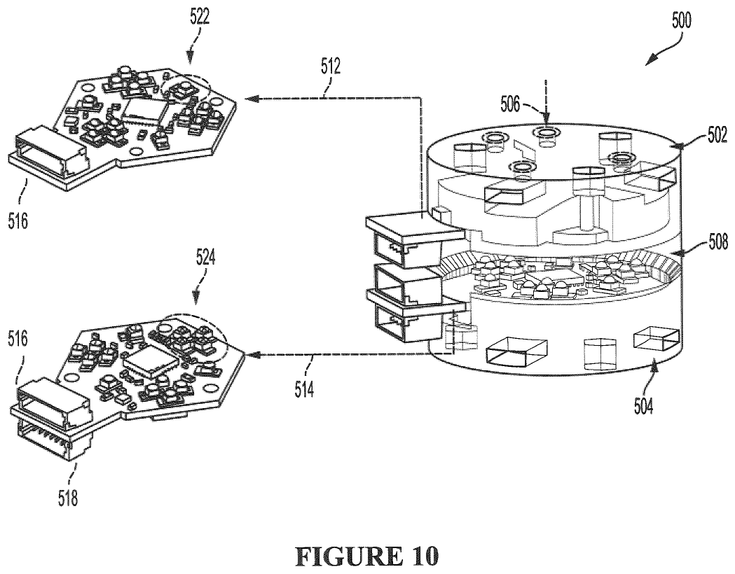

FIG. 10 illustrates another force torque sensor 500, according to an embodiment. In the illustrated example, the sensor 500 includes two rigid elements 502 and 504 connected in series by a flexure 508 that allows for 6-degrees of freedom (6-DOF) movement of the rigid elements 502 and 504, such as rigid plates. Devices 512 attached to the rigid element 502 and devices 514 attached to the rigid element 504 are for transmitting and receiving signals for sensing. In an example, devices 512 and 514 are LED circuit boards including LEDs. Devices 512 include an emitter 522 and devices 514 include a receiver 524. The emitter 522 and the receiver 524 can also be a cluster of emitting and receiving units, respectively. The flexure 508 is an elastic material that has a particular stiffness (K). With an applied force (F), the rigid elements 502 and 504 will displace according to Hooke's Law. By tracking the displacement with signals using devices 512 and 514, the applied force/torque can be calculated with the material properties. In some embodiments, the two rigid elements 502 and 504 are connected by the flexure 308 supporting an air gap.

In an embodiment, a first data interface 516 (for instance, a single JST connector) is implemented to communicate data between the top devices 512 and the bottom devices 514. A second data interface 518 (for instance, an additional JST connector) attached to the bottom devices 514 to communicate data with external electronics. The rigid elements 502 and 504 can be fitted with threaded holes 506 to mount external hardware.

In another embodiment, finite element analysis (FEA) can be used to simulate the deformation very easily. The material properties of the flexure include elastic modulus, shear modulus, tensile strength, compressive strength, and yield strength. Using PDMS is practical since it's a popular clear elastomer to be molded to any shape. Properties of PDMS have wide ranges and do not have a particular value since it depends on how the PDMS was fabricated, which varies based on several environmental factors that cannot be precisely controlled without industrial facilities. Therefore, experimentally determined properties using an Instron Machine and several test samples of PDMS are listed above in Table 3.

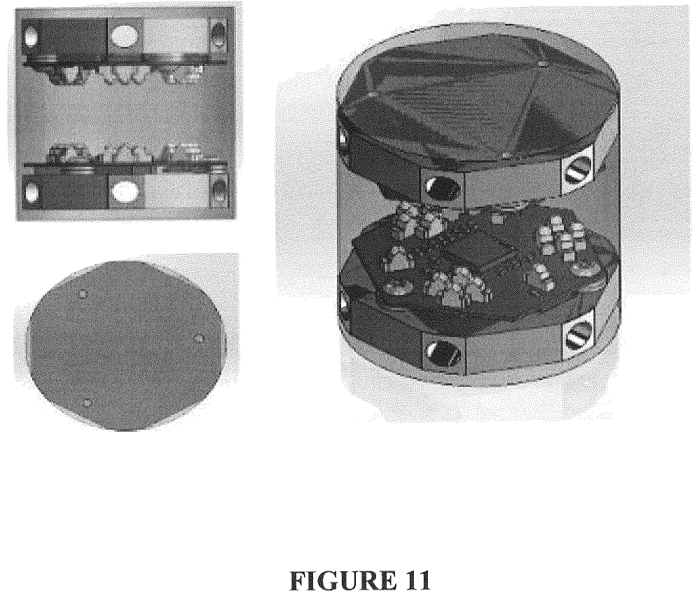

FIG. 11 illustrates a design of 6-axis sensor with a PCB design, in accordance with an embodiment. Suspending the plates in the PDMS flexure improves robustness to delamination. Mounting is to the side of the plate which will add significant thickness to the diameter of the overall finger.

Several mechanical designs of various complexity can be provided with the disclosed exemplary PCB board and derived material properties. In another example, mounting can be done to the top and bottom of the sensor and not the sides. Mounting to the sides adds material and increases the diameter by at least 5-6 millimeters.

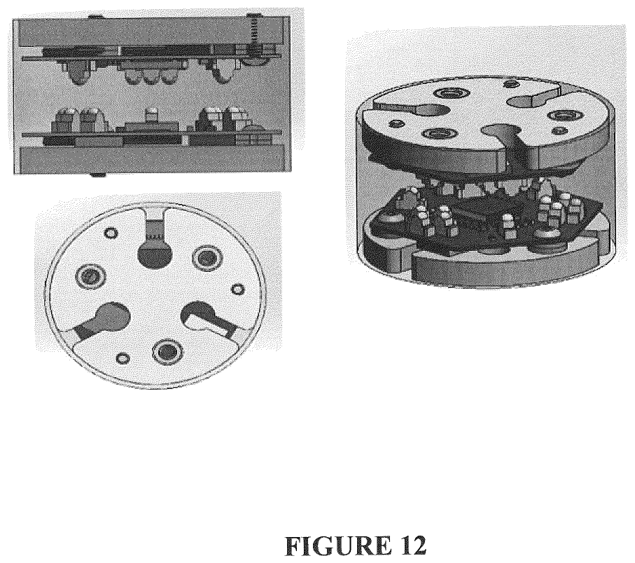

FIG. 12 illustrates another design of 6-axis sensor with the current PCB design, in accordance with an embodiment. The mounting holes are on the top and bottom of the plate. Some features are added to provide some anchoring points for the PDMS. Without damaging the PDMS flexure, it is also robust against the plates delaminating from the PDMS.

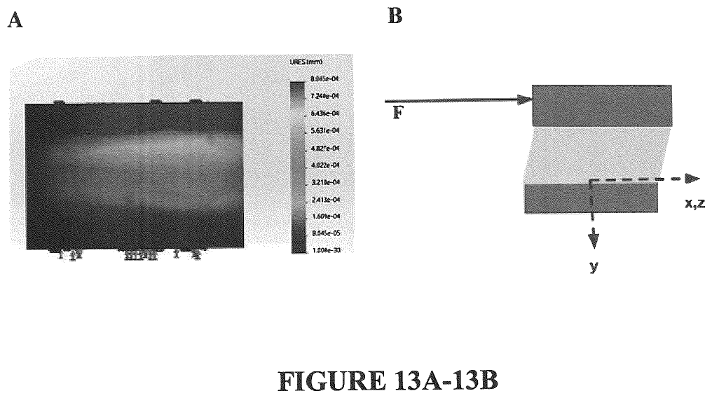

FIGS. 13A-13B illustrate FEA results for a lateral force applied to a sensor disclosed in the current application, in accordance with an embodiment. A high deflection from 10 N is around 8.0*10-4 mm. The electronics can produce a change in signal from such little displacement, given certain dimensions of the sensor. Various dimensions of the sensor can produce corresponding various levels of sensitivity.

In an embodiment, the FEA is used to determine displacement from different forces being applied to the sensor in a force range of 0.1N to 10N. Multiple force vectors are considered as well, to test the deformation in bending, tension, and compression. The electronics are able to relate a change in signal from these deformations to the appropriate force magnitude and vector applied.

Techniques of designing a 6-axis force/torque sensor are disclosed, with a goal being, e.g., to integrated the sensor into a robotic finger for haptic feedback. A dislocated sensor embedded within a finger link allows sensing of contact forces in all 3-axis, meaning that both normal and shear forces can be determined. Using a data-driven approach, the disclosed sensor is highly accurate. An aspect of the disclosed design is providing the sensor with small footprint, while still ensuring its robustness and accuracy. The mechanical design can withstand large forces, but also can deform from minimal contact (0.1N) such that the electronics see a change in a signal. And it can be related to the actual force being applied.

In another embodiment, a miniature, data-driven single axis torque cell is with a dislocated 6-axis sensor and a torque sensor at each joint. Such design can span the spectrum from haptic and proprioceptive control.

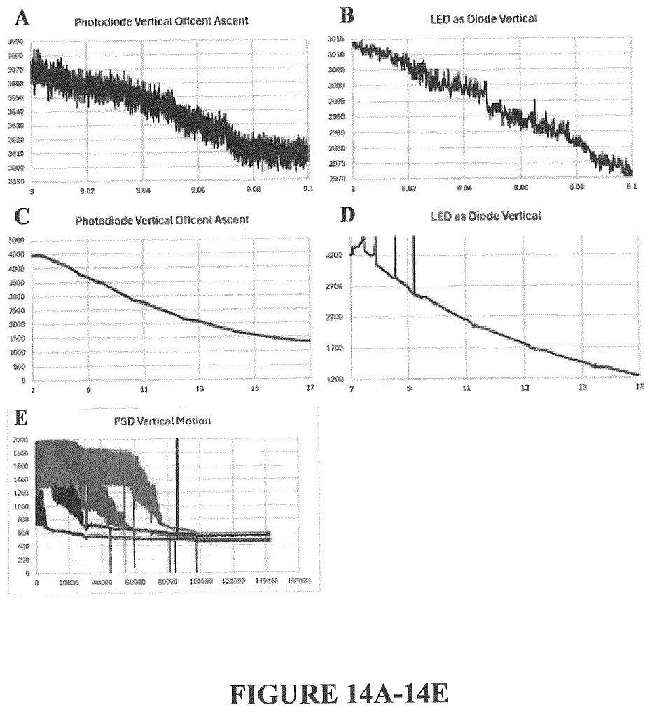

FIGS. 14A-14E are a series of graphs that further highlight differences between the Photodiode, the PSD, and the LED photodiode implementations, according to an embodiment. The first set shows the response to vertical displacements by all three photodiode options. It's worth noting that these graphs list the heights as being between 7 mm and 17 mm instead of 8.8 and 18.8, because they were made based on CAD estimates before re-verification of the heights to their more accurate measurements.

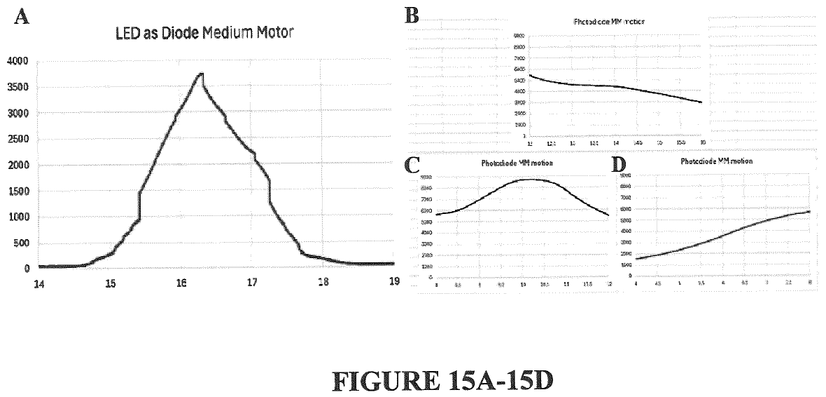

FIGS. 15A-15D compare the LED diode and the photodiode implementations over similar 4 mm ranges, showing a sharper response area of the LED, according to an embodiment.

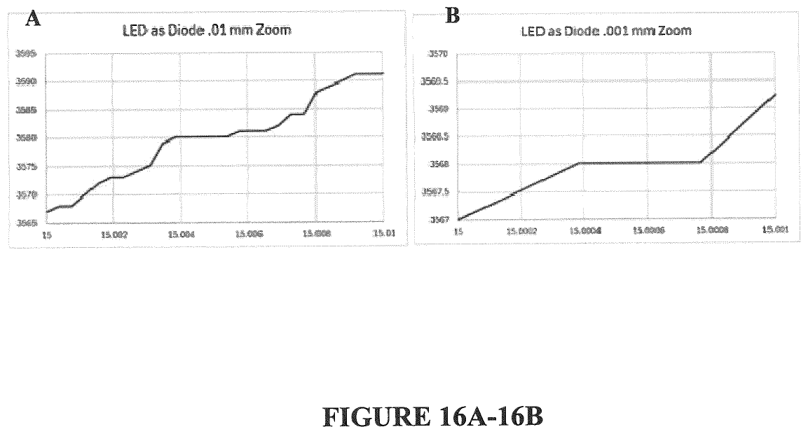

FIGS. 16A-16B show the LED as diode zoomed in greater than 0.1 mm, according to an embodiment. While not as clean as the 0.1 mm range, it still has a relatively decipherable signal over the noise, showing potential for even greater sensitivity for an actual sensor.

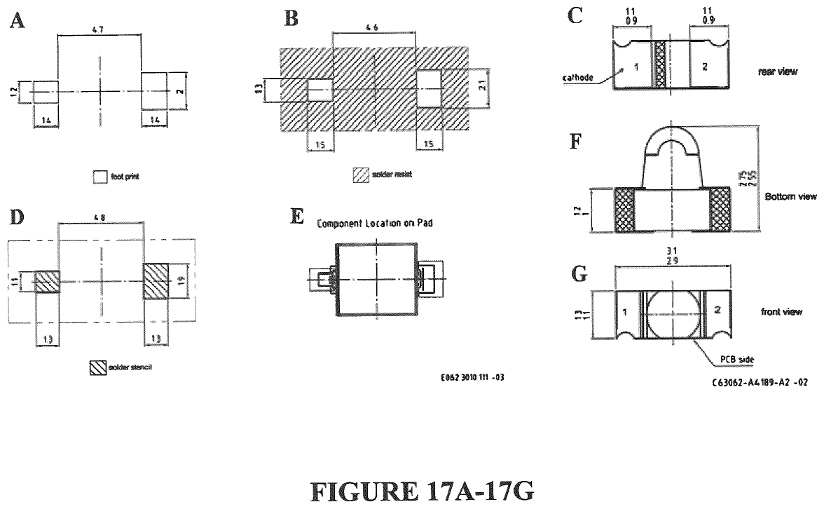

FIGS. 17A-17G illustrate footprints of the Photodiode (left) and the LED (right), according to an embodiment. This example shows why the LED is better for many design purposes. Namely it occupies a 3×1 mm area compared to the almost 5×5 mm area of the photodiode.

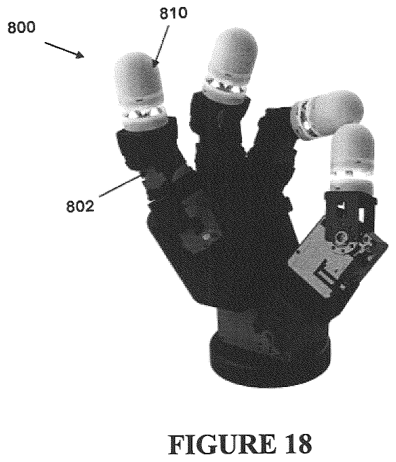

FIG. 18 illustrates a sensing apparatus 800, according to an embodiment. In the illustrated example, the sensing apparatus 800 is mounted with at least one force and torque sensor 810 at the base of at least one finger structure 802. As disclosed by the current application, the features of the sensor 810 make it particularly attractive for integration in the sensing apparatus 800, such as robot hands. In particular, the form factor and ease of integration (the sensor directly connects to a micro-controller board with no additional amplification electronics) are highly appealing. In an example, an anthropomorphic hand is mounted with one of our sensors at the base of the distal phalanx of each finger.

As will be apparent to one of ordinary skill in the art from a reading of this disclosure, the present disclosure can be embodied in forms other than those specifically disclosed above. The particular embodiments described above are, therefore, to be considered as illustrative and not restrictive. Those skilled in the art will recognize, or be able to ascertain, using no more than routine experimentation, numerous equivalents to the specific embodiments described herein. The scope of the invention is as set forth in the appended claims and equivalents thereof, rather than being limited to the examples contained in the foregoing description.

We claim:

1. A sensing apparatus, comprising:
a first structure having a first surface;
a second structure having a second surface;
an elastic material connecting the first surface of the first structure and the second surface of the second structure, the elastic material configured to displace in response to an external force;
a light source attached to the first surface of the first structure, the light source configured to emit a light beam; and
a light receiver attached to the second surface of the second structure, the light receiver configured to receive the light beam,
wherein an amount of the received light beam in relation to the emitted light beam is based on displacement of the elastic material in response to the external force.

2. The apparatus of claim 1, wherein at least one of the first structure and the second structure is configured to move with at least one degree of freedom.

3. The apparatus of claim 1, wherein the elastic material is a flexible structure configured to support an air gap.

4. The apparatus of claim 1, wherein the light source is a light-emitting diode (LED).

5. The apparatus of claim 1, wherein the light source is a laser device.

6. The apparatus of claim 1, wherein the light receiver is a photodiode.

7. The apparatus of claim 1, wherein the light receiver is a light-emitting diode (LED).

8. The apparatus of claim 1, further comprising a data converter configured to translate the amount of the received light beam to a digital signal.

9. The apparatus of claim 8, further comprising an actuator device, wherein the digital signal is configured to control a torque of the actuator device.

10. A sensing method, comprising:
connecting, by an elastic material, a first structure having a first surface and a second structure having a second surface;
emitting, by a light source attached to the first surface of the first structure, a light beam;
receiving, by a light receiver attached to the second surface of the second structure, the light beam; and
measuring an amount of the received light beam in relation to the emitted light beam,
wherein the measured amount of the received light beam is based on displacement of the elastic material in response to the external force.

11. The method of claim 1, wherein at least one of the first structure and the second structure is configured to move with at least one degree of freedom.

12. The method of claim 1, wherein the elastic material is a flexible structure configured to support an air gap.

13. The method of claim 1, wherein the light source is a light-emitting diode (LED).

14. The method of claim 1, wherein the light source is a laser device.

15. The method of claim 1, wherein the light receiver is a photodiode.

16. The method of claim 1, wherein the light receiver is a light-emitting diode (LED).

17. The method of claim 1, further comprising translating, by a data converter, the amount of the received light beam to a digital signal.

18. The method of claim 17, further comprising controlling, by the digital signal, a torque of an actuator device.

19. A sensing system, comprising:
a first structure having a first surface;
a second structure having a second surface;
an elastic material connecting the first surface of the first structure and the second surface of the second structure, the elastic material configured to displace in response to an external force;
a light source attached to the first surface of the first structure, the light source configured to emit a light beam;
a light receiver attached to the second surface of the second structure, the light receiver configured to receive the light beam, wherein an amount of the received light beam in relation to the emitted light beam is based on displacement of the elastic material in response to the external force; and
a data converter configured to translate the amount of the received light beam to a digital signal; and
one or more processors configured to process the digital signal.

20. The sensing system of claim 19, wherein the one or more processors are configured to process the digital signal using a machine learning model.
